(19) United States
(12) Patent Application Publication
(10) Pub. No.: US 2020/0050367 A1
(43) Pub. Date: Feb. 13, 2020

(54) STORAGE SYSTEM AND MANAGEMENT METHOD THEREOF

(71) Applicant: APACER TECHNOLOGY INC., New Taipei (TW)

(72) Inventor: Po-Jung Liu, New Taipei (TW)

(21) Appl. No.: 16/139,402

(22) Filed: Sep. 24, 2018

(30) Foreign Application Priority Data
Aug. 10, 2018 (TW) 107127939

(51) Int. Cl. G06F 3/06; G06F 9/38; G06F 9/50; G06F 11/34; G06F 17/30

(52) U.S. Cl. CPC G06F 3/0604; G06F 3/0631; G06F 9/3836; G06F 3/0671; G06F 11/3423; G06F 17/30997; G06F 17/30991; G06F 9/505

(57) ABSTRACT

A storage system capable of executing a managing operation based on timestamp and a management method are disclosed. The storage system includes a control unit and a memory unit connected to the control unit. The management method includes steps of: (a) issuing a control instruction comprising a timestamp to the control unit, wherein when the control unit receives the control instruction, the control unit starts to control the memory unit and accesses at least one storage space from the memory unit; and (b) sequentially counting plural numbers of instruction operations in plural time intervals, wherein the plural numbers of the instruction operations in each of the plural time intervals are stored in the at least one storage space. Since the peak period and the off-peak period of the storage system can be counted based on the timestamp, it facilitates the storage system to set a triggering time to execute a background operation.

### FIELD OF THE INVENTION

The present disclosure relates to a storage system, and more particularly to a storage system capable of executing a managing operation based on a timestamp and a management method thereof.

### BACKGROUND OF THE INVENTION

In order to manage storage space effectively, some background operations such as garbage collection (GC) and smart background data collection are performed in a conventional storage system, for example, while the storage system of a disk is idle for a period of time.

As to the triggering time of executing the aforementioned background operation procedure, since the conventional storage system performs a time calculation by a time clock after the conventional storage system is powered up, the time clock can record the time merely after the storage system is powered up. When the conventional storage system needs to trigger the aforementioned background operation procedure, it is necessary to determine a triggering time with a trigger threshold by the time clock. For example, the aforementioned background operation procedure is triggered to execute, while the accumulated time or the counting valve of the time clock exceeds the value of the trigger threshold.

However, in the storage system kept in operation for a long term, for example a storage system in a server, the idle time is short, so that it is difficult to set the trigger threshold for the background operation procedure, and it is difficult to distinguish between a peak period of heavy operations and an off-peak period. Consequently, the utilization of the background operation procedure is limited, and the flexibility of its function is also limited.

Therefore, there is a need of providing a storage system capable of executing a managing operation based on a timestamp and a management method thereof to solve the above-mentioned drawbacks in prior arts.

### SUMMARY OF THE INVENTION

An object of the present disclosure is to provide a storage system capable of executing a managing operation based on a timestamp and a management method thereof. By counting the numbers of the instruction operations in plural time intervals based on the timestamp, a peak period of heavy operations and an off-peak period for the storage system are determined so as to facilitate the storage system to set a triggering time of the background operation procedure during the off-peak period. It prevents the storage system from executing the background operation procedure during a peak period of heavy operations to influence the performance of the storage system. Moreover, in conjunction with setting a specific threshold or a counting number for the storage system to trigger the background operation procedure, it makes the timing of triggering the background operation procedure by the storage system more efficient and flexible.

Another object of the present disclosure is to provide a storage system capable of executing a managing operation based on a timestamp and a management method thereof. By introducing the timestamp to be associated with the action of counting the numbers of operations for the storage system, it facilitates the application program to visualize the obtained statistic data, so that the user can more intuitively understand the usage status of the storage system in real-time. Moreover, it is conducive to provide the enterprise customers with a configuration analysis of the server.

In accordance with an aspect of the present disclosure, a storage system is provided. The storage system includes a memory unit and a control unit. The memory unit includes at least one storage space. The control unit is connected with the memory unit. When the control unit receives a control instruction, the control unit starts to control the memory unit and accesses the at least one storage space of the memory unit. The control instruction includes a timestamp. The control unit sequentially counts plural numbers of instruction operations in each of plural time intervals according to the timestamp, and store the plural numbers of the instruction operations in the plural time intervals into the at least one storage space.

In an embodiment, the storage system further includes an application program module connected with the control unit to issue the control instruction to the control unit.

In an embodiment, the at least one off-peak period is selected from the plural time intervals through the control unit according to the plural numbers of the instruction operations in each of the plural time intervals.

In an embodiment, the application program module incudes a background operation instruction, wherein while the background operation instruction is issued to the control unit, the control unit selectively controls the memory unit according to the timestamp and the at least one off-peak period to execute the background operation instruction.

In an embodiment, the number of the instruction operations in the selected time interval corresponding to the at least one off-peak period is less than a preset threshold value or equal to zero.

In an embodiment, the application program module includes a query instruction issued to the control unit, wherein the query instruction comprises a query time period, wherein while the query instruction is issued to the control unit, the control unit compares the query time period with the timestamp to select a part of the plural numbers of the instruction operations in the plural time intervals from the at least one storage space and transmits the selected part of the plural numbers of the instruction operations in the plural time intervals corresponding to the query time period based on the timestamp to the application program module.

In an embodiment, at least one off-peak period and at least one peak period are selected from the plural time intervals through the control unit by comparing the plural numbers of the instruction operations in the plural time intervals, wherein the number of the instruction operations in the selected time interval corresponding to the at least one peak period is more than the number of the instruction operations in the selected time interval corresponding to the at least one off-peak period.

In an embodiment, the time interval is one selected form the group consisting of one second, one minute, one hour and a combination thereof.

In an embodiment, the number of the instruction operations is one selected from the group consisting of a number of reading instructions, a number of writing instructions, a number of deleting instructions, a number of resetting instructions and a combination thereof.

In accordance with another aspect of the present disclosure, a management method of a storage system is provided. The storage system includes a control unit and a memory unit connected with the control unit. The management method includes steps of: (a) issuing a control instruction to the control unit, wherein the control instruction comprises a timestamp, wherein when the control unit receives the control instruction, the control unit starts to control the memory unit and accesses at least one storage space from the memory unit; and (b) sequentially counting plural numbers of instruction operations in each of plural time intervals, wherein the plural numbers of the instruction operations in each of the plural time intervals are stored into the at least one storage space.

In an embodiment, the control instruction is issued by an application program module connected with the control unit.

In an embodiment, the management method further includes steps of: (c1) issuing a query instruction to the control unit by the application program module, wherein the query instruction comprises a query time period; (d1) comparing the query time period with the timestamp and selecting a part of the plural numbers of the instruction operations in the plural time intervals from the at least one storage space by the control unit; and (e1) transmitting the selected part of the plural numbers of the instruction operations in the plural time intervals corresponding to the query time period based on the timestamp to the application program module.

In an embodiment, the management method further includes steps of: (c2) issuing a background operation instruction to the control unit by the application program module; (d2) comparing the plural numbers of the instruction operations in each of the plural time intervals and selecting at least one off-peak period from the plural time intervals though the control unit; and (e2) selectively controlling the memory unit according to the timestamp and the at least one off-peak period to execute the background operation instruction by the control unit.

In an embodiment, the number of the instruction operations in the selected time interval corresponding to the at least one off-peak period is less than a preset threshold value or equal to zero.

In an embodiment, the management method further includes step of (c3) comparing the plural numbers of the instruction operations in each of the plural time intervals and selecting at least one off-peak period and at least one peak period from the plural time intervals through the control unit, respectively, wherein the number of the instruction operations in the selected time interval corresponding to the at least one peak period is more than the number of the instruction operations in the selected time interval corresponding to the at least one off-peak period.

In an embodiment, the time interval is one selected form the group consisting of one second, one minute, one hour and a combination thereof.

In an embodiment, the number of the instruction operations is one selected from the group consisting of a number of reading instructions, a number of writing instructions, a number of deleting instructions, a number of resetting instructions and a combination thereof.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a functional block illustrating a storage system and an application program module applied thereto according to an embodiment of the present disclosure;

FIG. 2 is a flow chart illustrating a management method of the storage system according a first embodiment of the present disclosure;

FIG. 3 is a first exemplary content in the storage space of the storage system of the present disclosure;

FIG. 4 is a second exemplary content in the storage space of the storage system of the present disclosure;

FIG. 5 shows that the control unit selects a part of the plural numbers of the instruction operations in the plural time intervals from the storage space by comparing a query time period with the timestamp;

FIG. 6 is a first exemplary view illustrating the content of the plural numbers of the instruction operations in the plural time intervals stored in the storage space and displayed on a display module;

FIG. 7 is a second exemplary view illustrating the content of the plural numbers of the instruction operations in the plural time intervals stored in the storage space and displayed on the display module;

FIG. 8 is a third exemplary view illustrating the content of the plural numbers of the instruction operations in the plural time intervals stored in the storage space and displayed on the display module;

FIG. 9 is a fourth exemplary view illustrating the content of the plural numbers of the instruction operations in the plural time intervals stored in the storage space and displayed on the display module;

FIG. 10 is a flow chart illustrating a management method of the storage system according a second embodiment of the present disclosure;

FIG. 11 is a first exemplary content illustrating the plural numbers of the instruction operations in a specific period of time intervals;

FIG. 12 is a second exemplary content illustrating the plural numbers of the instruction operations in a specific period of time intervals; and

FIG. 13 is a flow chart illustrating a management method of the storage system according a third embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

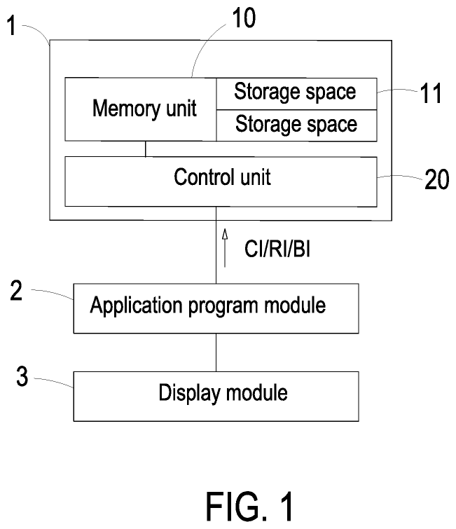

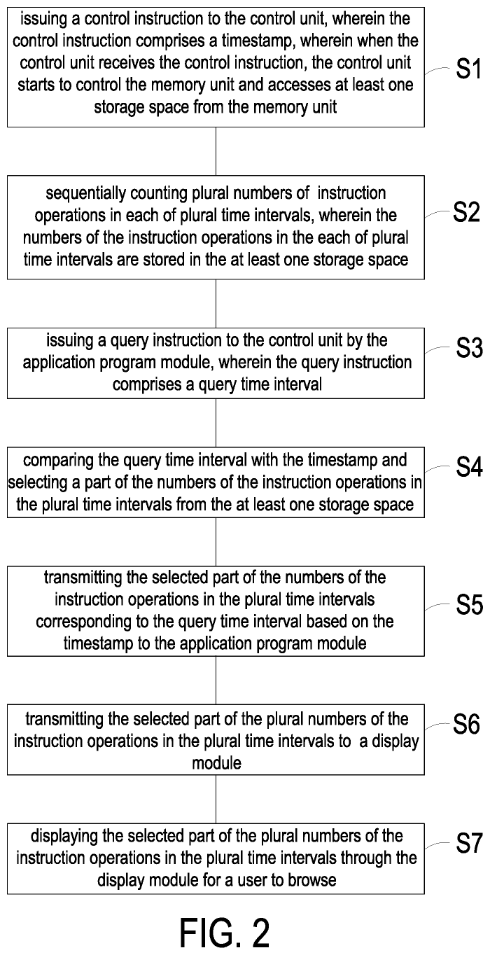

FIG. 1 is a functional block illustrating a storage system and an application program module applied thereto according to an embodiment of the present disclosure. FIG. 2 is a flow chart illustrating a management method of the storage system according a first embodiment of the present disclosure. The storage system 1 includes a memory unit 10 and a control unit 20. The memory unit 10 includes at least one storage space 11. The control unit 20 is connected with the memory unit 10 and configured to control the memory unit 10. In the embodiment, the control unit 20 of the storage system 1 is further connected with an application program module 2. The application program module 2 is configured to issue at least one control instruction CI to the control unit 20. Firstly, at the step S1, when the control unit 20 of the storage system 1 receives the control instruction CI, the control unit 20 starts to control the memory unit 10 and accesses at least one storage space 11 from the memory unit 10. The control instruction CI includes a timestamp, for example the time of 2018-06-01 15:00:00, which the storage system 1 is initialized thereat. Then, at the step S2, the control unit 20 sequentially counts plural numbers of instruction operations in each of plural time intervals according to the timestamp, wherein each time interval is for example but not limited to one hour. In the embodiment, the plural numbers of the instruction operations in each of the plural time intervals are stored into the at least one storage space 11. In other embodiment, the each time interval can be for example but not limited to one second, one minute, ten minutes or several hours.

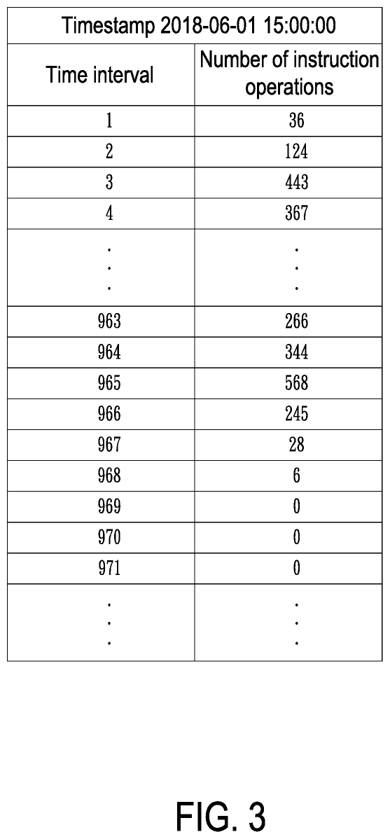

FIG. 3 is a first exemplary content in the storage space of the storage system of the present disclosure. When the control unit 20 receives the timestamp contained in the control instruction CI, the control unit 20 starts to sequentially count plural numbers of the instruction operations in plural time intervals, for example one number of the instruction operations is counted in each one hour, and the plural counted numbers are stored into the storage space 11 of the memory unit 10. In an embodiment, after the control instruction CI with the timestamp, for example 2018-06-01 15:00:00, is received, there are for example 1000 time intervals based on the timestamp. Namely, there are 1000 numbers of the instruction operations in 1000 time intervals, respectively. In other words, the instruction operations of the storage system 1 are counted in each time interval, respectively, from the timestamp 2018-06-01 15:00:00 to 1000 hours and the counted numbers are stored into the storage space 11. There are 1000 numbers of the instruction operations in 1000 time intervals and stored in the storage spacing 11. In the embodiment, the number of the instruction operations is a number of reading or writing instructions for memory unit 10. In other embodiment, the number of the instruction operations is one selected from the group consisting of a number of reading instructions, a number of writing instructions, a number of deleting instructions, a number of resetting instructions and a combination thereof. It should be noted that the target of instruction operations for counting is adjustable according to the practical requirement. The present disclosure is not limited thereto, and not redundantly described herein.

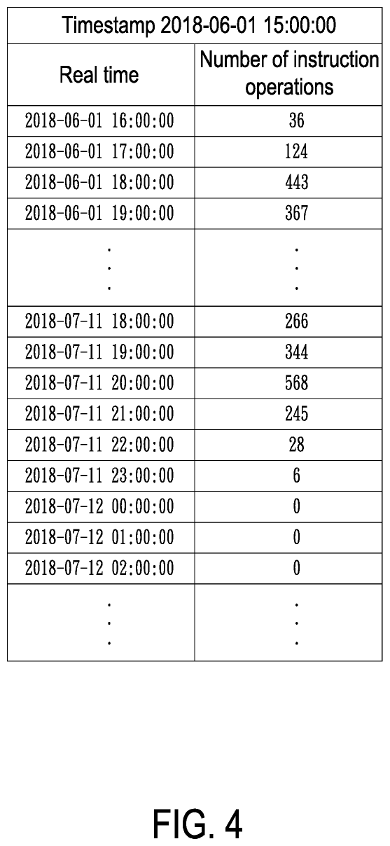

FIG. 4 is a second exemplary content in the storage space of the storage system of the present disclosure. In the embodiment, when the control unit 20 receives the timestamp contained in the control instruction CI, the control unit 20 starts to sequentially count plural numbers of the instruction operations in plural time intervals, for example one number of the instruction operations is counted in each one hour. The control unit 20 further transforms the plural time intervals into the real time based on the timestamp, for example the time of 2018-06-01 15:00:00, which the storage system 1 is initialized thereat. The plural numbers of the instruction operations in real time are stored in the storage space 11. In the embodiment, the instruction operations of the storage system 1 are counted in each time interval, respectively, from the timestamp 2018-06-01 15:00:00 to 1000 hours and the counted numbers are stored into the storage space 11. There are 1000 numbers of the instruction operations in 1000 time interval and stored in the storage spacing 11. Namely, each number of instruction operations of each hour in the period from 2018-06-01 15:00:00 to 2018-07-13 07:00:00 is stored into the storage space 11. The present disclosure is not limited thereto.

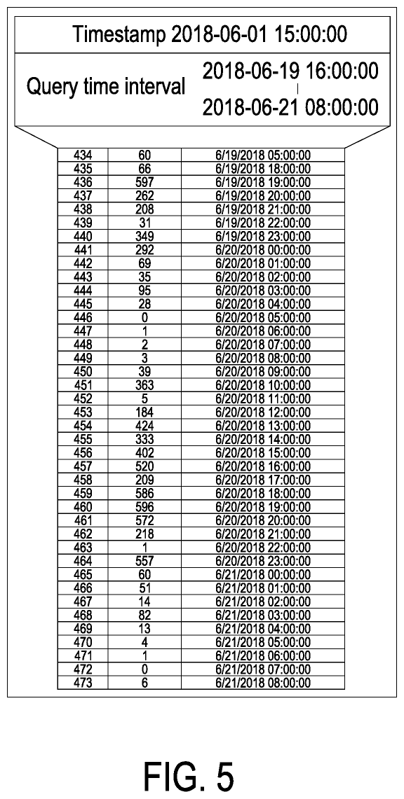

Then, at the step S3, a query instruction RI is further issued to the control unit 20 of the storage system 1 by the application program module 2. The query instruction RI includes a query time period, which is ranged for example from 2018-06-19 16:00:00 to 2018-06-21 08:00:00. Afterward, at the step S4, when the control unit 20 receives the query instruction RI, the control unit 20 selects a part of the plural numbers of the instruction operations in the plural time intervals from the storage space 11 by comparing the query time period with the timestamp. Then, at the step S5, the selected part of the plural numbers of the instruction operations in the plural time intervals are transmitted to the application program module 2. FIG. 5 shows that the control unit selects a part of the plural numbers of the instruction operations in the plural time intervals from the storage space by comparing a query time period with the timestamp. In the embodiment, the query time period is ranged for example from 2018-06-19 16:00:00 to 2018-06-21 08:00:00, which have the numbers of the instruction operations of the plural time intervals ranged from the 434th time interval to 473th time interval, as shown in FIG. 5. In other words, the user can query the number of the instruction operations in each time interval from the storage space 11. In the embodiment, the application program module 2 is, for example, an application program installed in the host server, and is configured to issue a control instruction CI with the timestamp to the control unit 20 of the storage system 1.

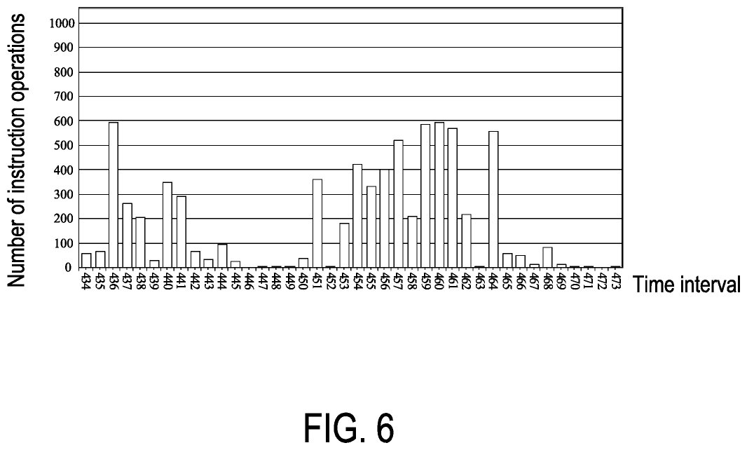

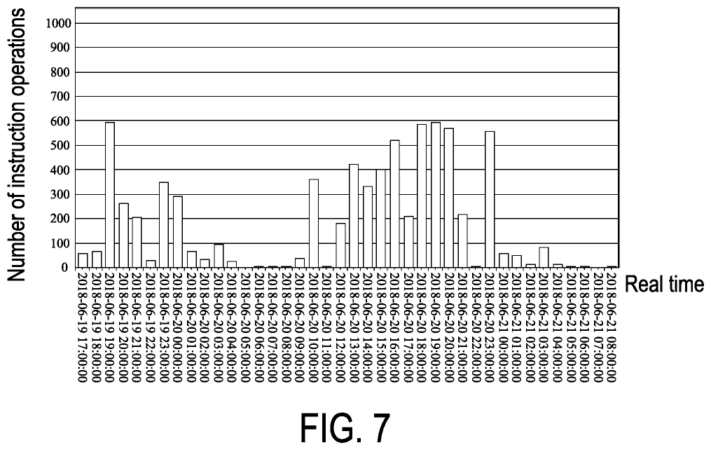

In the embodiment, the application program module 2 is further connected with a display module 3. At the step S6, the selected part of the plural numbers of the instruction operations in the plural time intervals are further transmitted to the display module 3. Under this circumstance, the plural numbers of the instruction operations in the plural time intervals, which are stored in the storage space 11, can be selectively displayed through the display module 3 by the application program module 2, for a user to browse, as shown at the step S7. FIG. 6 is a first exemplary view illustrating the content of the plural numbers of the instruction operations in the plural time intervals stored in the storage space and displayed on a display module. In the embodiment, each of the plural numbers of instruction operations in the query time period ranged for example from 2018-06-19 16:00:00 to 2018-06-21 08:00:00, represented as the plural time intervals ranged from the 434th time interval to 473th time interval, is illustrated in the graph of FIG. 6. FIG. 7 is a second exemplary view illustrating the content of the plural numbers of the instruction operations in the plural time intervals stored in the storage space and displayed on the display module. Alternatively, each of the plural numbers of instruction operations in the query time period ranged for example from 2018-06-19 16:00:00 to 2018-06-21 08:00:00 is illustrated in the graph of FIG. 7.

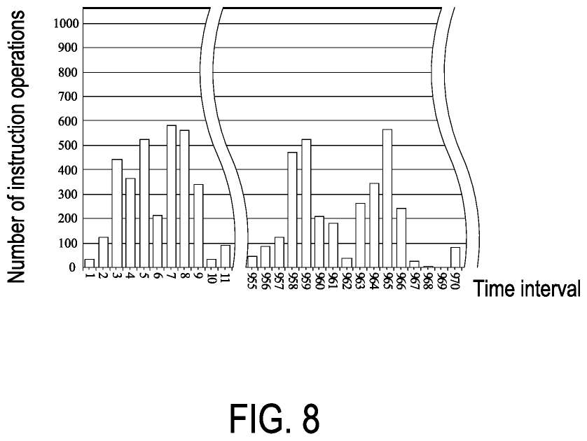

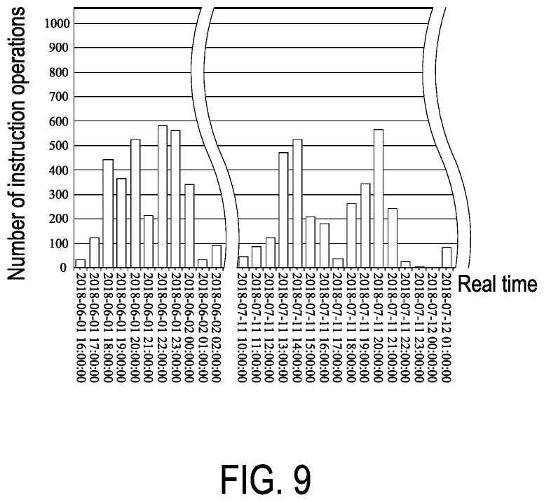

It should be emphasized that the user can query the number of the instruction operations in any subsequent time interval based on the timestamp and stored in the storage space 11. In an embodiment, the display module 3 can immediately display any part of the plural numbers of instruction operations in the plural time intervals and stored in the storage space 11 of the storage system 1 for the user to browse. FIG. 8 is a third exemplary view illustrating the content of the plural numbers of the instruction operations in the plural time intervals stored in the storage space and displayed on the display module. The user can query any part of the plural numbers of the instruction operations in the plural subsequent time interval based on the timestamp and stored in the storage space 11. In other embodiment, the plural numbers of instruction operations in the plural time intervals, which are stored in the storage space 11, are immediately presented in real time by the display module 3 for the user to browse, as shown in FIG. 9. By visualizing the result in the graph, the user can more intuitively understand the usage status of the storage system 1 in real time. The present disclosure is not limited thereto and not redundantly described herein.

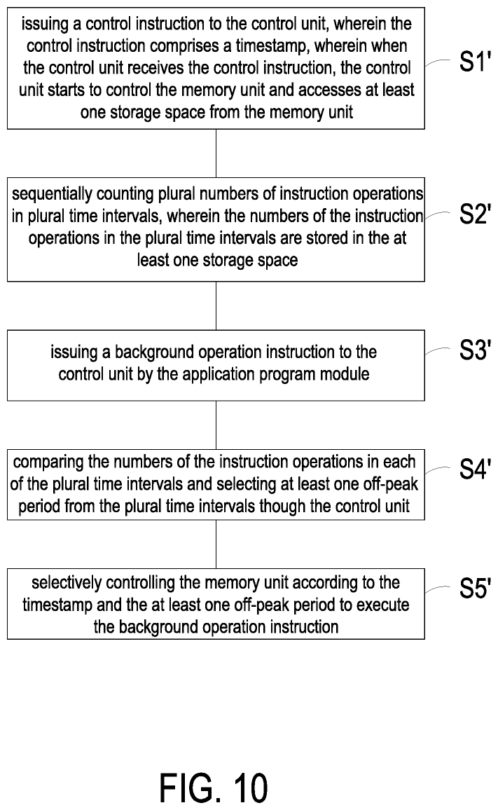

FIG. 10 is a flow chart illustrating a management method of the storage system according a second embodiment of the present disclosure. As shown in FIGS. 1 and 10, the steps S1′ and S2′ are similar to the steps S1 and S2 of FIG. 2, and not redundantly described herein. In the embodiment, at the step S1′ and S2′, the storage system 1 stores the plural numbers of the instruction operations in the plural time intervals in the storage space 11 based on the received timestamp. At the step S3′, a background operation instruction BI, such as data backup instruction, is further issued to the control unit 20 of the storage system 1 by the application program module 2. Then, at the step S4′, when the control unit 20 receives the background operation instruction BI, at least one off-peak period is selected from the plural time intervals through the control unit 20 by comparing each of the plural numbers of the instruction operations in each of the plural time intervals. In the embodiment, the number of the instruction operations in the selected time interval corresponding to the at least one off-peak period is less than a preset threshold value or equal to zero. The present disclosure is not limited thereto.

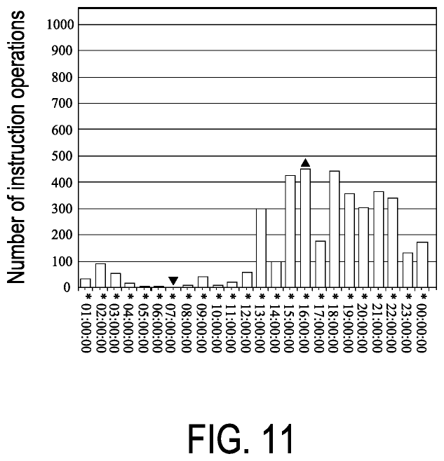

FIG. 11 is a first exemplary content illustrating the plural numbers of the instruction operations in a specific period of time intervals. In the embodiment, a specific period of 24 hours a day is taken as an example. At least one off-peak period can be selected from the plural time intervals through the control unit according to the plural number of the instruction in each of the plural time interval. For example, comparing to those of the other time intervals, the numbers of the instruction operations in the time intervals ranged for example from 06:00:00 to 07:00:00 are lower and even close to zero. Accordingly, the control unit 20 can select the time interval ranged for example from 06:00:00 to 07:00:00 as an off-peak period. Finally, at the step S5′, the control unit 20 selectively controls the memory unit 10 according to the timestamp and the at least one off-peak period to execute the background operation instruction BI. For example, the background operation instruction BI, such as data backup instruction, is triggered to execute. Thus, it makes the timing of triggering the background operation corresponding to the background operation instruction by the storage system 1 more efficient and flexible.

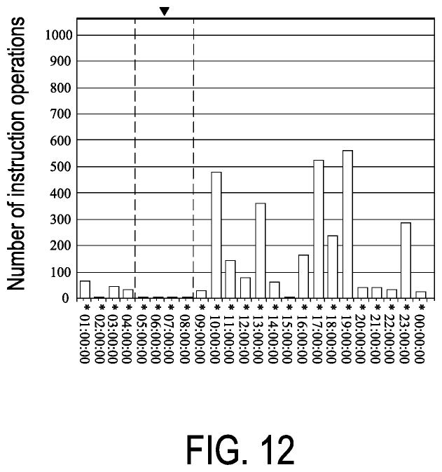

FIG. 12 is a second exemplary content illustrating the plural numbers of the instruction operations in a specific period of time intervals. In the embodiment, the application program module 2 further issues the background operation instruction BI, such as a defragmentation instruction, a garbage collection (GC) instruction or a smart background data collection instruction, to the control unit 20 of the storage system 1. While in selecting the off-peak period, the control unit 20 selects the continuous time intervals ranged for example from 04:00:00 to 08:00:00 as an off-peak period of four hours. At the step S5′, the control unit 20 selectively controls the memory unit 10 according to the timestamp and the off-peak period of four hours ranged for example from 04:00:00 to 08:00:00. Accordingly, the background operation instruction BI, such as a defragmentation instruction, a garbage collection (GC) instruction or a smart background data collection instruction, is triggered to execute during the four hours ranged from 04:00:00 to 08:00:00 of the next day. Thus, it makes the timing of triggering the background operation corresponding to the background operation instruction by the storage system 1 more efficient and flexible.

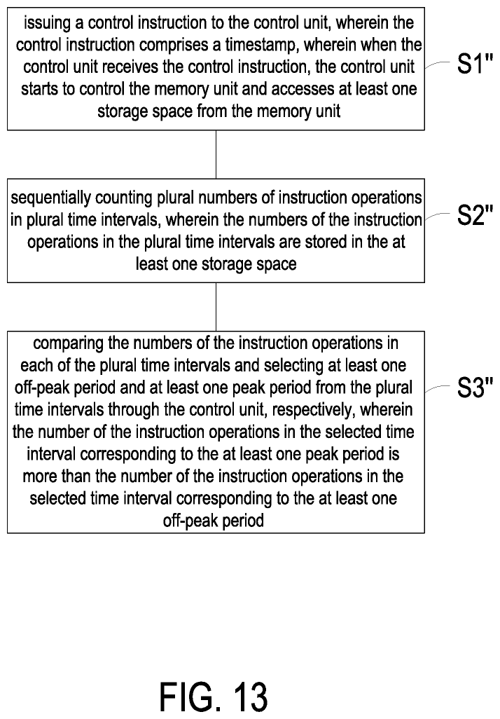

FIG. 13 is a flow chart illustrating a management method of the storage system according a third embodiment of the present disclosure. As shown in FIGS. 1 and 13, the steps S1″ and S2″ are similar to the steps S1 and S2 of FIG. 2, and not redundantly described herein. In the embodiment, at the step S1″ and S2″, the storage system 1 stores the plural numbers of the instruction operations in the plural time intervals, which are stored in the storage space 11, based on the received timestamp. At the step S3″, at least one off-peak period and at least one peak period are selected from the plural time intervals through the control unit 1 by comparing the plural numbers of the instruction operations in each of the plural time intervals, respectively. The number of the instruction operations in the selected time interval corresponding to the at least one peak period is more than the number of the instruction operations in the selected time interval corresponding to the at least one off-peak period. While the specific period of time intervals in FIG. 11 is taken as an example, the off-peak period can be ranged for example from 06:00:00 to 07:00:00, and the peak period can be ranged for example from 15:00:00 to 16:00:00. In this way, the user can query the status of the storage system 1 in any specific period. For example, while the numbers of the instruction operations in several continuous time intervals, selected as the off-peak period, are zero, it represents that the storage system 1 might be powered off, re-powered up or in a sleeping mode during the corresponding time intervals, so that the user can more intuitively understand the usage status of the storage system in real-time. It is conducive to provide the enterprise customers with a configuration analysis of the server.

In summary, the present disclosure provides a storage system capable of executing a managing operation based on a timestamp and a management method thereof. By counting a peak period of heavy operations and an off-peak period based on the timestamp, it facilitates the storage system to set a triggering time of the background operation procedure during the off-peak period. It prevents the storage system from executing the background operation procedure during a peak period of heavy operations to influence the performance of the storage system. Moreover, in conjunction with setting a specific threshold or a counting number for the storage system to trigger the background operation procedure, it makes the timing of triggering the background operation procedure by the storage system more efficient and flexible. In addition, by introducing the timestamp to count the numbers of the operations for the storage system, it facilitates the application program to visualize the obtained statistic data, so that the user can more intuitively understand the usage status of the storage system in real-time. Moreover, it is conducive to provide the enterprise customers with a configuration analysis of the server.

While the disclosure has been described in terms of what is presently considered to be the most practical and preferred embodiments, it is to be understood that the disclosure needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A storage system comprising:
a memory unit comprising at least one storage space; and
a control unit connected with the memory unit, wherein when the control unit receives a control instruction, the control unit starts to control the memory unit and accesses the at least one storage space of the memory unit, wherein the control instruction comprises a timestamp, the control unit sequentially counts plural numbers of instruction operations in each of plural time intervals according to the timestamp, and stores the plural numbers of the instruction operations in the plural time intervals into the at least one storage space.

2. The storage system according to claim 1, further comprising an application program module connected with the control unit to issue the control instruction to the control unit.

3. The storage system according to claim 2, wherein at least one off-peak period is selected from the plural time intervals through the control unit according to the plural numbers of the instruction operations in each of the plural time intervals.

4. The storage system according to claim 3, wherein the application program module comprises a background operation instruction, wherein while the background operation instruction is issued to the control unit, the control unit selectively controls the memory unit according to the timestamp and the at least one off-peak period to execute the background operation instruction.

5. The storage system according to claim 3, wherein the number of the instruction operations in the selected time interval corresponding to the at least one off-peak period is less than a preset threshold value or equal to zero.

6. The storage system according to claim 2, wherein the application program module comprises a query instruction issued to the control unit, wherein the query instruction comprises a query time period, wherein while the query instruction is issued to the control unit, the control unit compares the query time period with the timestamp to select a part of the plural numbers of the instruction operations in the plural time intervals from the at least one storage space and transmits the selected part of the plural numbers of the instruction operations in the plural time intervals corresponding to the query time period based on the timestamp to the application program module.

7. The storage system according to claim 2, wherein at least one off-peak period and at least one peak period are selected from the plural time intervals through the control unit by comparing the plural numbers of the instruction operations in the plural time intervals, wherein the number of the instruction operations in the selected time interval corresponding to the at least one peak period is more than the number of the instruction operations in the selected time interval corresponding to the at least one off-peak period.

8. The storage system according to claim 1, wherein the time interval is one selected form the group consisting of one second, one minute, one hour and a combination thereof.

9. The storage system according to claim 1, wherein the number of the instruction operations is one selected from the group consisting of a number of reading instructions, a number of writing instructions, a number of deleting instructions, a number of resetting instructions and a combination thereof.

10. A management method of a storage system, wherein the storage system comprises a control unit and a memory unit connected with the control unit, and the management method comprises steps of:
(a) issuing a control instruction to the control unit, wherein the control instruction comprises a timestamp, wherein when the control unit receives the control instruction, the control unit starts to control the memory unit and accesses at least one storage space from the memory unit;
(b) sequentially counting plural numbers of instruction operations in each of plural time intervals, wherein the plural numbers of the instruction operations in each of the plural time intervals are stored in the at least one storage space.

11. The management method according to claim 10, wherein the control instruction is issued by an application program module connected with the control unit.

12. The management method according to claim 11, further comprising steps of:
(c1) issuing a query instruction to the control unit by the application program module, wherein the query instruction comprises a query time period;
(d1) comparing the query time period with the timestamp and selecting a part of the plural numbers of the instruction operations in the plural time intervals from the at least one storage space; and
(e1) transmitting the selected part of the plural numbers of the instruction operations in the plural time intervals corresponding to the query time period based on the timestamp to the application program module.

13. The management method according to claim 11, further comprising steps of:
(c2) issuing a background operation instruction to the control unit by the application program module;
(d2) comparing the plural numbers of the instruction operations in each of the plural time intervals and selecting at least one off-peak period from the plural time intervals though the control unit; and
(e2) selectively controlling the memory unit according to the timestamp and the at least one off-peak period to execute the background operation instruction.

14. The management method according to claim 13, wherein the number of the instruction operations in the selected time interval corresponding to the at least one off-peak period is less than a preset threshold value or equal to zero.

15. The management method according to claim 10, further comprising step of:
(c3) comparing the plural numbers of the instruction operations in each of the plural time intervals and selecting at least one off-peak period and at least one peak period from the plural time intervals through the control unit, respectively, wherein the number of the instruction operations in the selected time interval corresponding to the at least one peak period is more than the number of the instruction operations in the selected time interval corresponding to the at least one off-peak period.

16. The management method according to claim 10, wherein the time interval is one selected form the group consisting of one second, one minute, one hour and a combination thereof.

17. The management method according to claim 10, wherein the number of the instruction operations is one selected from the group consisting of a number of reading instructions, a number of writing instructions, a number of deleting instructions, a number of resetting instructions and a combination thereof.
